(19) United States
(12) Patent Application Publication
(10) Pub. No.: US 2026/0133929 A1
(43) Pub. Date: May 14, 2026

(54) AUDIO SYNCHRONIZATION METHOD FOR USB DEVICE, USB DEVICE, STORAGE MEDIUM AND COMMUNICATION SYSTEM

(71) Applicant: AMLOGIC (SHENZHEN) CO., LTD, Shenzhen (CN)

(72) Inventors: Shengken Lin, Shenzhen (CN); Manliang Tang, Shenzhen (CN)

(21) Appl. No.: 19/285,109

(22) Filed: Jul. 30, 2025

(30) Foreign Application Priority Data
Nov. 12, 2024 (CN) 202411608284.2

(51) Int. Cl. G06F 13/42; G06F 3/16; G06F 13/24

(52) U.S. Cl. CPC G06F 13/4282; G06F 3/16; G06F 13/24; G06F 2213/0042

(57) ABSTRACT

The present disclosure discloses an audio synchronization method for a USB device, a USB device, a storage medium and a communication system. The audio synchronization method for a USB device includes: obtaining an SOF clock calculated by the USB device, the SOF clock calculated by the USB device being obtained by simulating an SOF interrupt through software and recording a timestamp of the SOF interrupt; obtaining a target clock frequency of the USB device based on a clock frequency of a USB host, an SOF clock of the USB host and the SOF clock calculated by the USB device; and adjusting a clock frequency of the USB device based on the target clock frequency of the USB device.

### CROSS-REFERENCE TO RELATED APPLICATION

The present application claims priority to Chinese Patent Application No. 202411608284.2 filed with China National Intellectual Property Administration on Nov. 12, 2024 and entitled “AUDIO SYNCHRONIZATION METHOD FOR USB DEVICE, USB DEVICE, STORAGE MEDIUM AND COMMUNICATION SYSTEM”, which is incorporated herein by reference in its entirety.

### TECHNICAL FIELD

The present disclosure relates to the technical field of communication, and more particularly, to an audio synchronization method for a USB device, a USB device, a storage medium and a communication system.

### BACKGROUND

In embedded audio systems, USB (Universal Serial Bus), as one of the most common audio transmission media, is widely used for audio data transmission between a USB host (such as a computer) and a USB device (such as a headphone, a sound card, etc.). When the USB host acts as a data transmitter and the USB device serves a receiver, audio data is transmitted from the host to the device through the USB interface. After receiving the data, the device transmits it to the sound card for playback, finishing one audio transmission. To ensure the continuity of audio transmission, clock synchronization between the USB host and USB device is critically important. Due to the fact that there is usually a certain difference between the clock frequency of the host and the clock frequency of the device, with a continuous transmission of audio data, this inconsistency in clock frequency can lead to accumulation errors of data, resulting in a loss or desynchronization of audio data especially during prolonged continuous transmission, affecting the stability of transmission and sound quality.

In the relative art, there are mainly two synchronous transmission methods for USB audio data. One method is to introduce a feedback endpoint on the device. The device periodically sends the audio data frequency currently required by the device to the host through the feedback endpoint, requesting the host to adjust the transmission volume of audio data. Although the method can achieve synchronous adjustment, it relies on the stationarity and controllability of the host hardware, and thus it is unable to adapt to any type of the USB host and has significant limitations. The other method is based on a buffer mechanism, that is to set up an audio buffer on the device and dynamically adjust a device clock frequency based on the buffer's status. However, the method has a problem, that is there is a certain delay in buffer adjustment. When data errors accumulate to a certain extent, the adjustment is triggered. Therefore, it is unable to apply to audio transmission scenarios in which high real-time requirement should be satisfied, especially for audio synchronization applications that require high clock accuracy. Audio loss or synchronization errors cannot be completely avoided.

### SUMMARY

The present disclosure aims to resolve at least one of the technical problems in the related art. Therefore, a first aim of the present disclosure is to provide an audio synchronization method for a USB device, which can achieve real-time adjustment of a clock frequency on the USB device, thereby realizing a synchronous transmission between a USB host and the USB device, reducing accumulative errors of audio transmission and avoiding a issue of data loss or inaccurate synchronization. At the same time, the method is no longer limited to specific USB host hardware so that a universality of USB audio data transmission is enhanced.

A second aim of the present disclosure is to provide a USB device.

A third aim of the present disclosure is to provide a computer readable storage medium.

A fourth aim of the present disclosure is to provide a communication system.

To achieve the above aims, an embodiment of a first aspect of the present disclosure provides an audio synchronization method for a USB device. The method includes: obtaining an SOF clock calculated by the USB device, the SOF clock calculated by the USB device being obtained by simulating an SOF interrupt through software and recording a timestamp of the SOF interrupt; obtaining a target clock frequency of the USB device based on a clock frequency of a USB host, an SOF clock of the USB host and the SOF clock calculated by the USB device; and adjusting a clock frequency of the USB device based on the target clock frequency of the USB device.

In the audio synchronization method for a USB device according to the embodiment of the present disclosure, an SOF clock calculated by the USB device can be obtained by simulating an SOF (Start of Frame) interrupt through software and recording a timestamp of the SOF interrupt, the SOF interrupt is a signal sent at the beginning of each data transmission cycle in a USB protocol and indicates a start of a frame of data. By simulating the interrupt, the USB device can record the timestamps of interrupts at predetermined time intervals, so that a clock reference on the device is established. The clock reference can accurately reflect clock frequency variations of the USB device during actual operation. Combining the clock frequency of the USB host with the SOF clock of the USB host, a target clock frequency of the USB device can be calculated. The target clock frequency can accurately reflect a frequency difference between the USB host and the USB device. By adjusting the clock frequency of the USB device in real-time, the synchronous audio transmission between the USB host and the USB device is achieved, effectively reducing the accumulation errors of audio data caused by clock frequency inconsistency, thereby avoiding the issue of audio data loss or inaccurate synchronization. At the same time, since the method is based on the SOF interrupts and timestamp calculations rather than relying on specific USB host hardware, it ensures the adaptability of the method to any type of the USB host, thereby improving the universality of USB audio data transmission and can meet audio transmission requirements for high real-time performance and high precision.

In some embodiments, the obtaining the SOF clock calculated by the USB device includes simulating SOF interrupts in a preset time duration through software and recording the timestamp of each SOF interrupt; obtaining a fitted curve of timestamps based on the recorded timestamps of the SOF interrupts; and obtaining the SOF clock calculated by the USB device based on the fitted curve of timestamps.

In some embodiments, the preset time duration is a preset time duration in which the USB host starts to send USB data.

In some embodiments, the simulating the SOF interrupts in the preset time duration through the software and recording the timestamp of each SOF interrupt includes enabling a timer to start counting when receiving a first SOF interrupt sent by the USB host; enabling, after delaying for a first preset duration, the timer to monitor a micro-frame counter at intervals of a second preset duration, the micro-frame counter being incremented by 1 each time a USB data micro-frame is received from the USB host, the first preset duration being shorter than a time interval at which the USB host sends the SOF interrupt, the second preset duration being shorter than the first preset duration; and finishing, in response to a count of the micro-frame counter reaching a preset counting threshold, a simulation of the first SOF interrupt, a current timer value of the timer being a timestamp of the first SOF interrupt.

In some embodiments, the first preset duration+the second preset duration*the preset counting threshold=the time interval at which the USB host sends the SOF interrupt.

In some embodiments, the simulating the SOF interrupts in the preset time duration through the software and recording the timestamp of each SOF interrupt further includes performing a polling step, the polling step including clearing the micro-frame counter after a count of the micro-frame counter reaches the preset counting threshold, and enabling, after delaying for the first preset duration, the timer to count to monitor the micro-frame counter at intervals of the second preset duration, finishing, in response to the count of the micro-frame counter reaching the preset counting threshold, the simulation of one SOF interrupt, the current timer value of the timer being the timestamp of the SOF interrupt that is currently being simulated; and repeating the polling step, until a timer value of the timer reaches the preset time duration.

In some embodiments, the audio synchronization method for a USB device further includes delaying, when the count of the micro-frame counter does not reach the preset counting threshold, for a third preset duration and then returning to the step of enabling the timer to monitor the micro-frame counter, the third preset duration being shorter than the second preset duration.

In some embodiments, for an USB full-speed transmission mode, a value of the first preset duration t1 meets: 0.75 ms≤t1≤0.85 ms.

In some embodiments, the obtaining the fitted curve of timestamps based on the recorded timestamps of the SOF interrupts includes obtaining data of timestamps of the SOF interrupts within a fourth preset duration from the USB host starting to play data for the first time; and obtaining the fitted curve of timestamps based on the data of timestamps of the SOF interrupts using a linear regression model.

In some embodiments, the SOF clock calculated by the USB device is a slope of a timestamp simulation curve.

In some embodiments, the obtaining the target clock frequency of the USB device based on the clock frequency of the USB host, the SOF clock of the USB host and the SOF clock calculated by the USB device includes obtaining the target clock frequency based on a proportional relationship of the clock frequency of the USB host, the SOF clock of the USB host, the SOF clock calculated by the USB device and the target clock frequency of the USB device.

In some embodiments, the target clock frequency of the USB device is obtained by the formula of:

$$\frac{{F}_{d} - {F}_{h}}{{F}_{d}} \times {10}^{6} = \frac{{T}_{d} - {T}_{h}}{{T}_{d}} \times {10}^{6} ;$$

F_{d} is the target clock frequency, Fₕ is the clock frequency of the USB host, T_{d} is the SOF clock calculated by the USB device, and Tₕ is the SOF clock of the USB host.

To achieve the above aims, a USB device according to an embodiment of a second aspect of the present disclosure includes: at least one processor; and a memory communicatively connected to the at least one processor. The memory stores a computer program executable by the at least one processor. The computer program, when executable by the at least one processor, implements the audio synchronization method for a USB device according to any one of the above embodiments.

In the USB device according to the embodiment of the present disclosure, at least one processor can achieve a synchronization between the clock frequency of the USB device and the clock frequency of the USB host by executing the computer program for the audio synchronization method for a USB device in any of the above embodiments. Specifically, the SOF clock calculated by the USB device can be obtained by simulating SOF (Start of Frame) interrupts through software and recording timestamps of the SOF interrupts. The clock can accurately reflect clock frequency variations of the USB device during the actual operation. Combining the clock frequency of the USB host and the SOF clock of the USB host, the target clock frequency of the USB device can be calculated. The target clock frequency can accurately reflect the frequency difference between the USB host and the USB device. By adjusting the clock frequency of the USB device in real-time, synchronous audio transmission between the USB host and the USB device can be achieved, effectively reducing the accumulation errors of audio data caused by clock frequency inconsistency, thereby avoiding the issue of audio data loss or inaccurate synchronization. At the same time, since the method is based on the SOF interrupts and timestamp calculations rather than relying on specific USB host hardware, it ensures the adaptability of the method to any type of the USB host, thereby improving the universality of USB audio data transmission and can meet audio transmission requirements for high real-time performance and high precision.

To achieve the above aims, a computer readable storage medium according to an embodiment in a third aspect embodiment of the present disclosure is provided. The computer readable storage medium stores a computer program. The computer program when executed, implements the audio synchronization method for a USB device in any of the above embodiments.

The computer readable storage medium according to the embodiment of the present disclosure can achieve the real-time adjustment of the clock frequency of the USB device by using the audio synchronization method for a USB device in any of the above embodiments, and can achieve synchronous audio transmission between the USB host and the USB device, reduce the accumulation errors of audio transmission and avoid the issue of audio data loss or inaccurate synchronization. At the same time, the method is no longer limited to specific USB host hardware, thereby improving the universality of USB audio data transmission and meeting audio transmission requirements for high real-time performance and high precision.

To achieve the above aims, a communication system according to an embodiment of a fourth aspect of the present disclosure includes: a USB host and at least one USB device mentioned in any of the above embodiments, the USB host being communitively connected to the USB device via a USB bus.

In the communication system according to the embodiment of the present disclosure, the USB host is communitively connected to the USB device via a USB bus. The SOF clock calculated by the USB device can be obtained by simulating SOF (Start of Frame) interrupts through software and recording timestamps of the SOF interrupts. The clock can accurately reflect clock frequency variations of the USB device during the actual operation. Combining the clock frequency of the USB host and the SOF clock of the USB host, the target clock frequency of the USB device can be calculated. The target clock frequency can accurately reflect the frequency difference between the USB host and the USB device. By adjusting the clock frequency of the USB device in real-time, synchronous audio transmission between the USB host and the USB device can be achieved, thereby effectively reducing the accumulation errors of audio data caused by clock frequency inconsistency, and avoiding the issue of audio data loss or inaccurate synchronization. At the same time, since the method is based on the SOF interrupts and timestamp calculations rather than relying on specific USB host hardware, it ensures the adaptability of the method to any type of the USB host, thereby improving the universality of USB audio data transmission and meeting audio transmission requirements for high real-time performance and high precision.

The additional aspects and advantages of the present disclosure will be partially presented in the following description, partially become apparent from the description below, or be understood through the practice of the present disclosure.

### BRIEF DESCRIPTION OF THE DRAWINGS

The above and/or other additional aspects and advantages of the present disclosure become apparent and comprehensible from the description of embodiments in connection with accompanying drawings, in which:

FIG. 1 is a flow chart of an audio synchronization method for a USB device according to an embodiment of the present disclosure;

FIG. 2 is a schematic diagram of advance or delay in the interruption of USB audio data transmission according to an embodiment of the present disclosure;

FIG. 3 is a schematic diagram of using a timer to detect a USB micro-frame counter for recording a timestamp of an SOF interrupt according to an embodiment of the present disclosure;

FIG. 4 is a flow chart for recording the timestamp of the SOF interrupt according to an embodiment of the present disclosure;

FIG. 5 is an overall flowchart of an audio synchronization method for a USB device according to an embodiment of the present disclosure;

FIG. 6 is a block diagram of a USB device according to an embodiment of the present disclosure; and

FIG. 7 is a block diagram of a communication system according to an embodiment of the present disclosure.

### REFERENCE NUMERALS

communication system 100;
USB device 1; USB host 2
Processor 11; Memory 12.

### DETAILED DESCRIPTION

The embodiments of the present disclosure will be described below in detail. The embodiments described with reference to the accompanying drawings are exemplary.

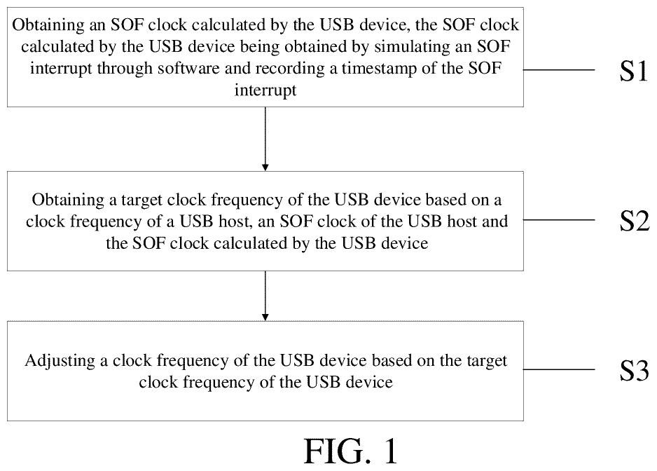

With reference to FIGS. 1 to 5, an audio synchronization method for a USB device according to an embodiment of the present disclosure is described below.

FIG. 1 is a flow chart of an audio synchronization method for a USB device according to an embodiment of the present disclosure. As shown in FIG. 1, the audio synchronization method for a USB device according to the embodiment of the present disclosure at least includes steps S1 to S3.

At step S1, an SOF clock calculated by the USB device is obtained. The SOF clock calculated by the USB device is obtained by simulating an SOF interrupt through software and recording a timestamp of the SOF interrupt.

In some embodiments, the SOF clock calculated by the USB device can refer to a clock signal calculated by the USB device during operation based on a received SOF interrupt signal, the clock signal being used to identify a start of each data frame. The role of the SOF clock calculated by the USB device is to provide a timing reference for data transmission between the USB host and the USB device. The clock signal provides, for the USB device, a timing reference between each data frame, so that it is able to reflect clock frequency variations of the USB device during actual operating, and thus can provide precise basis for subsequent clock frequency adjustments.

In some embodiments, the SOF interrupt is an interrupt signal issued at a beginning of each transmission cycle in a USB protocol, and indicates the start of a data frame. The role of the SOF interrupt is to maintain synchronization between the USB host and the USB device, ensuring the correct reception and processing of data frames. If the SOF interrupt is premature, lost, or delayed, it may lead to inaccurate data transmission, affecting audio synchronization and data integrity.

In some embodiments, the SOF interrupt timestamp can refer to a system time or timer value recorded each time an SOF interrupt occurs. By recording a plurality of SOF interrupt timestamps, the USB device can calculate its SOF clock. The collection and analysis of these timestamps provide a necessary time reference for the USB device to perform frequency adjustment and ensure the real-time nature of data transmission.

In some embodiments, simulating SOF interrupts through software can be implemented by using various programming languages and frameworks. For example, the code can be written in C/C++ and the simulation of SOF interrupts is implemented through timer API (Application Programming Interface) provided by an operation system. Furthermore, dedicated embedded development frameworks (such as FreeRTOS, Zephyr, etc.) can also be used, the SOF interrupt can be simulated through a timer and a task scheduling function.

In addition, in some embodiments, obtaining the SOF clock calculated by the USB device can further be achieved by other ways, for example, a hardware timer capture, a dedicated clock capture module, a built-in logic circuit, an FPGA, an external trigger, and a pulse detection circuit, etc. These methods are implemented through the SOF interrupt signal generated by a hardware controller, the SOF interrupt signal is triggered every 1 millisecond, and indicates a start of a new data frame. In contrast, in the present disclosure, simulating the SOF interrupt signal through software can enable the realization of SOF signal timing control in software without the need for dedicated hardware intervention, and obtain a reliable time reference, thereby enhancing the universality of USB audio data transmission, allowing the USB audio data transmission to be unrestricted by USB host hardware and to be applicable to any type of USB host, including hosts that are uncontrollable or do not support clock feedback.

At step S2, a target clock frequency of the USB device is obtained based on a clock frequency of a USB host, an SOF clock of the USB host and the SOF clock calculated by the USB device.

In some embodiments, the clock frequency of the USB host can refer to a frequency of a reference clock signal used by the host to control data transmission and manage communication and is usually expressed in Hertz (Hz) as a unit. The clock frequency of the host provides a timing foundation for USB communication, ensuring that each frame of data can be transmitted and received within a correct time interval. The clock frequency of the host is a reference for data transmission in the USB system. Through the frequency, the USB device can parse data and synchronously process the data based on the signal of the host, thereby ensuring stable transmission of audio and other data.

In some embodiments, the clock frequency on the USB host can be a fixed value determined by the protocol standard and hardware design. For example, in USB2.0, the clock frequency of the USB host is 48 MHz.

In some embodiments, the SOF clock of the USB host can refer to a frequency of the SOF signal generated by the USB host. The SOF signal indicates a beginning of each frame of data. The SOF clock refers to a periodic frequency of the SOF signal. The SOF clock of the USB host provides a frame synchronization signal to the USB device, enabling the USB device to accurately identify the starting position of each data frame. This helps to maintain communication synchronization between the host and device, particularly in scenarios with high real-time requirements such as audio data transmission. The SOF signal being premature, lost, or delayed may lead to data loss or inaccurate synchronization.

In some embodiments, in the standard USB protocol, the frequency of the SOF clock of the USB host is a known value. For example, an SOF clock cycle in USB2.0 is 1 ms (millisecond), with a frequency of 1000 Hz.

In some embodiments, the target clock frequency of the USB device can be an ideal frequency value derived by comprehensively considering the clock frequency of the USB host, the SOF clock of the USB host, and the SOF clock calculated by the USB device. The target clock frequency is a clock frequency that the USB device needs to adjust to when synchronizing with the host, in order to ensure timing consistency between the USB device and the USB host. The target clock frequency of the USB device directly affects an audio synchronization quality between the device and the host. If there is a deviation between an actual clock frequency on the device end and the target clock frequency, it may cause cumulative audio data delay or distortion.

At step S3, a clock frequency of the USB device is adjusted based on the target clock frequency of the USB device.

In some embodiments, the USB device can adjust its internal clock signal based on the calculated target clock frequency, to ensure that the actual clock frequency of the device remains consistent with the target clock frequency. The target clock frequency is an ideal value that reflects the clock frequency that should be used by the device when the device performs data synchronization with the host. This adjustment process can be achieved by modifying an internal clock generator (such as a phase-locked loop (PLL), a frequency divider, etc.) of the USB device. The Phase-Locked Loop (PLL) can dynamically adjust an output frequency to make the output frequency match the target clock frequency. The frequency divider can further adjust the clock frequency by performing frequency division or frequency multiplication on the clock signal. The adjusted clock frequency ensures that the clock signal of the device remains consistent with the clock signal of the host, particularly in real-time audio synchronization scenarios, preventing audio data loss, delay, or distortion caused by clock deviation. Through the process, stable data transmission and processing can be achieved.

In some embodiments, the clock frequency adjustment of USB device is a dynamic process. With a monitoring of the SOF interrupt signals during device operation, the USB device can calculate the target clock frequency in real-time and perform frequency adjustments based on a newly calculated target clock frequency. The dynamic adjustment mechanism can compensate for the clock frequency deviation of the device during actual operation. By continuously adjusting the target clock frequency, the device can maintain precise synchronization with the host, especially for high-demand audio transmission, ensuring smooth audio data transfer and reducing data loss or synchronization errors caused by clock discrepancies.

In the audio synchronization method for a USB device according to the embodiment of the present disclosure, the SOF (Start of Frame) clock calculated by the USB device can be obtained by simulating SOF interrupts through software and recording the timestamp of the SOF interrupt. The SOF interrupt is a signal sent at a beginning of each data transmission cycle in the USB protocol, and indicates a start of a data frame. By simulating the interrupt, the USB device can record the timestamp of the interrupt within a predetermined time interval, thereby establishing a clock reference of the USB device. The clock reference can accurately reflect clock frequency variations of the USB device during actual operation. Combining the clock frequency of the USB host and the SOF clock of the USB host, the target clock frequency of the USB device can be calculated. The target clock frequency can accurately reflect the frequency difference between the USB host and the USB device. By adjusting the clock frequency on the USB device in real-time, synchronization of audio transmission between the USB host and the USB device is achieved, effectively reducing the audio data accumulation error caused by clock frequency discrepancies, thus preventing issues such as audio data loss or inaccurate synchronization. At the same time, since the method is based on the SOF interrupts and timestamp calculations rather than relying on specific USB host hardware, it ensures the adaptability of the method to any type of USB host, thereby improving the universality of USB audio data transmission and can meet audio transmission requirements for high real-time performance and high precision.

In some embodiments, the obtaining the SOF clock calculated by the USB device includes: simulating SOF interrupts in a preset time duration through software and recording the timestamp of each SOF interrupt; obtaining a fitted curve of timestamps based on the recorded timestamps of the SOF interrupts; and obtaining the SOF clock calculated by the USB device based on the fitted curve of timestamps.

In some embodiments, the preset time duration is a preset time duration in which the USB host starts to send USB data. The preset time duration is set within the time range for simulating SOF interrupts on the USB device. The time range allows the system to perform plurality of SOF interrupt simulations, enabling the capture of more timestamp data for SOF interrupts within a certain period, thereby improving the accuracy of subsequent calculations.

In some embodiments, recording the timestamp of each SOF interrupt can be achieved by utilizing a timer to detect a micro-frame counter, thereby reducing calculation errors caused by software processing. The micro-frame counter is a counter used in USB 2.0 and above standards to track frames and micro-frames. Each USB frame has a duration of 1 millisecond, and each frame is further divided into 8 micro-frames (each micro-frame has a duration of 125 microseconds). Each time a micro-frame signal arrives, the micro-frame counter will increase by one. Its function is to track the number of micro-frames in a current SOF frame, providing an accurate time reference on the USB device.

Thus, the function of the micro-frame counter is to provide the device with an accurate time reference in USB communication, and is to measure the timing of frames and micro-frames during transmission. The micro-frame counter can automatically increase within each micro-frame (125 microseconds), thereby providing fine-grained timing information during frame transmission. By detecting the value of the micro-frame counter, the USB device can accurately determine time when each SOF interrupt occurs, particularly in scenarios requiring high-precision timing and synchronization.

In some embodiments, a fitted curve of timestamps can be formed by fitting a plurality of consecutive SOF interrupt timestamps. The timestamp fitted curve can reflect the actual occurrence frequency of SOF interrupts of the USB device. Through the fitting result, the deviation of the device clock frequency relative to the host clock frequency can be derived. Specifically, the USB device can utilize linear regression or other data fitting algorithms to process timestamp data, fitting the frequency variation curve of the SOF interrupt on the device. The fitting algorithm can be implemented by using common mathematical tools or mathematical libraries in programming languages. For example, in programming languages such as C/C++ and Python, the polyfit( ) function from the NumPy library can be used for multi-point fitting, or a customized least squares fitting algorithm can be written as needed. The fitted curve can reflect the overall variation trend of the SOF interrupt signal. For example, the device can utilize data from plurality of consecutive SOF interrupt time points and perform linear fitting by using the least squares method. The fitted curve can help to derive the specific deviation of the device clock frequency relative to the host clock frequency, thereby providing a basis for subsequent clock adjustments.

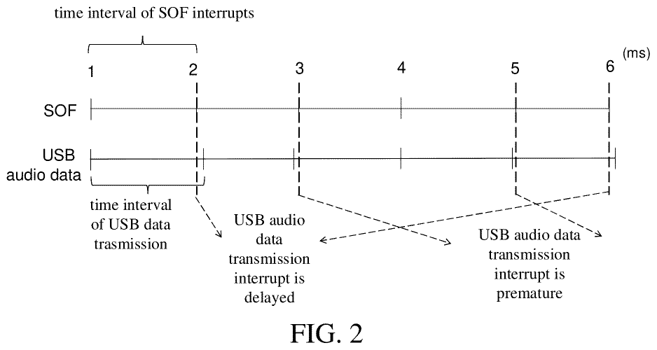

FIG. 2 is a schematic diagram of the existence of advance or delay in the interruption of USB audio data transmission according to an embodiment of the present disclosure. As shown in FIG. 2, SOF interrupt behavior is simulated by analyzing the transmission rules of USB audio data packets. Specifically, when USB audio data transmission begins, the time interval for each USB audio data transfer is consistent with the SOF interrupt time interval. Taking a USB full-speed transmission as an example, the USB performs a data transmission every 1 ms. However, due to the influence of the system scheduling mechanism, USB audio data transmission interruptions may be in advance or delayed.

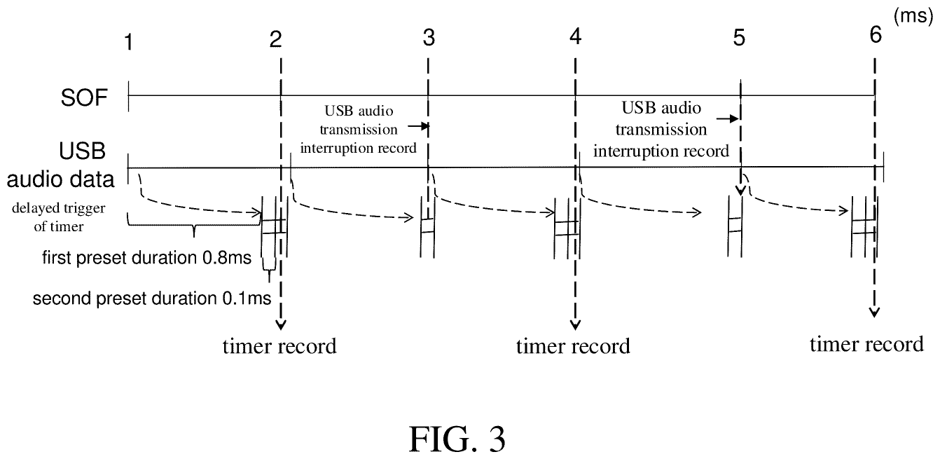

Furthermore, as shown in FIG. 3, by utilizing a timer to detect the micro-frame counter, the timestamp of each SOF interrupt can be accurately recorded. Specifically, a timer is enabled to start counting when receiving a first SOF interrupt sent by the USB host. After delaying for a first preset duration, the timer is enabled to monitor a micro-frame counter at intervals of a second preset duration. The micro-frame counter is incremented by 1 each time a USB data micro-frame is received from the USB host. The first preset duration is shorter than a time interval at which the USB host sends the SOF interrupt, the second preset duration is shorter than the first preset duration. In response to a count of the micro-frame counter reaching a preset counting threshold, a simulation of the first SOF interrupt is finished, a current timer value of the timer is a timestamp of the first SOF interrupt.

A setting of the first preset duration is primarily based on a timing requirement of USB audio transmission and a need to avoid interference to audio data transmission. In USB2.0 audio transmission standard, a period of each frame is 1 millisecond (ms). This means that every millisecond, the device will receive or send audio data. Thus, the first preset duration needs to be set within this 1-millisecond transmission cycle. However, it must be shorter than a time interval of USB audio transmission in order to timely complete the simulation of SOF interrupts during audio data transmission.

In some embodiments, as shown in FIG. 3, the first preset duration can be set to 0.8 ms (milliseconds), which is a reasonable first preset duration. It is shorter than 1 ms (millisecond) audio frame transmission interval and provides a sufficient time window (0.2 milliseconds) for the timer to detect the micro-frame counter. In this way, it can prevent data loss and error accumulation, ensuring the accuracy of simulating SOF interruptions.

In some embodiments, the second preset duration is a time interval at which the timer periodically detects the micro-frame counter after startup. The duration of the time interval should be set according to the transmission time of USB micro-frames and the requirement of the system.

In some embodiments, as shown in FIG. 3, the second preset duration can be set to 0.1 ms (100 microseconds). The micro-frame cycle of USB2.0 is 125 microseconds. Therefore, setting the second preset duration to 100 microseconds is appropriate. This means that every 100 microseconds, the timer will detect a change in the micro-frame counter, so as to ensure sufficient time to capture changes before the end of each 125-microsecond micro-frame cycle. If the second preset duration is set to be too long, it may result in the inability to timely detect update of the micro-frame counter and thus affect the accuracy of SOF interrupt simulation.

In some embodiments, when the value of the micro-frame counter reaches a preset counting threshold, it indicates that the USB device has successfully received a certain number of micro-frame data during the simulating SOF interrupts. This process provides the USB device with the necessary time reference, enabling it to accurately generate timestamps for SOF interrupts, thereby considering these timestamps as representing the SOF interrupts actually occurred within the data stream.

In some embodiments, the first preset duration+the second preset duration*the preset counting threshold=the time interval at which the USB host sends the SOF interrupt. The time interval at which the USB host sends the SOF interrupt is determined by the USB host in accordance with the USB protocol standard, and is typically 1 millisecond (in USB2.0). This time interval is a fundamental cycle for USB audio data transmission, ensuring the synchronization and continuity of the audio data.

The above equation ensures temporal consistency throughout the SOF interrupts simulation process. This means that the total time used throughout the entire simulation process must equal to the time interval of the SOF interrupt of the USB host, thereby ensuring audio data transmission synchronization of the USB device. By precisely controlling these timing parameters, accurate SOF interrupt simulation can be achieved, avoiding premature or delay phenomena of SOF interrupt simulation, thereby ensuring audio quality.

In some embodiments, the simulating the SOF interrupts in the preset time duration through the software and recording the timestamp of each SOF interrupt further include: performing a polling step. The polling step can involve the system periodically detecting a timer and a micro-frame counter to cyclically simulate SOF interrupts. After finishing each simulation, the system clears the micro-frame counter and re-enters the polling loop to continue subsequent simulation of SOF interrupts. The polling step ensures the continuity of SOF interrupt simulation and timestamp recording until the preset time condition is met.

In some embodiments, the polling step includes: clearing the micro-frame counter after a count of the micro-frame counter reaches the preset counting threshold, and enabling, after delaying for the first preset duration, the timer to count to monitor the micro-frame counter at intervals of the second preset duration, finishing, in response to the count of the micro-frame counter reaching the preset counting threshold, the simulation of one SOF interrupt, the current timer value of the timer being the timestamp of the SOF interrupt that is currently simulated; repeating the polling step, until a timer value of the timer reaches the preset time duration. That is, the system deems that sufficient SOF interrupts have been simulated and adequate timestamp data has been acquired for subsequent synchronization operations.

In some embodiments, the audio synchronization method for a USB device further includes: delaying, when the count of the micro-frame counter does not reach the preset counting threshold, for a third preset duration and then returning to the step of enabling the timer to monitor the micro-frame counter, the third preset duration being shorter than the second preset duration.

specifically, when the timer detects the count of the micro-frame counter according to the second preset duration, if the count of the micro-frame counter does not reach the preset counting threshold, it indicates that the simulation of the SOF interrupt has not yet been completed. In the situation, the system will not immediately perform detection again, but will instead wait for a third preset duration. The third preset duration is a time interval shorter than the second preset duration. By delaying this relatively short duration, the system can avoid detecting the micro-frame counter too frequently, but at the same time can ensure that the counter can be detected again within an appropriate time duration to capture the changes in the preset counting threshold. The mechanism ensures that the system does not waste excessive processing time, and will not miss critical changes in the micro-frame counter.

Furthermore, after the delay for the third preset duration ends, the system returns to the timer and re-detect the count of the micro-frame counter. If the count of the micro-frame counter reaches the preset counting threshold, the system can finish simulation of the SOF interrupt and record the timestamp. If the count of the micro-frame counter dose not reach the preset counting threshold, delay for the third present duration is performed again and detection is continued until the count of the counter meets the condition.

In some embodiments, the third preset duration can be adjusted according to real-time performance requirements and detection accuracy of the system. The third preset duration should be shorter than the second preset duration to ensure the completion of a new detection operation before the next micro-frame count update. For example, if the second preset duration is set to 0.1 ms (milliseconds), then the third preset duration can be set to 10 us (microseconds). During this time period, the system will not immediately attempt to detect the micro-frame counter again, but rather waits for end of this brief delay before proceeding with detection.

In some embodiments, for a USB full-speed transmission mode, a value of the first preset duration t1 meets: 0.75 ms≤t1≤0.85 ms. The range can effectively help capture of the actual time point of SOF interrupt, ensuring that the system accurately records the SOF interrupt signal within the Ims frame cycle. By setting this preset duration, synchronization issues caused by system scheduling and software calculation errors can be significantly reduced, thereby ensuring temporal synchronization throughout the entire USB audio data transmission process.

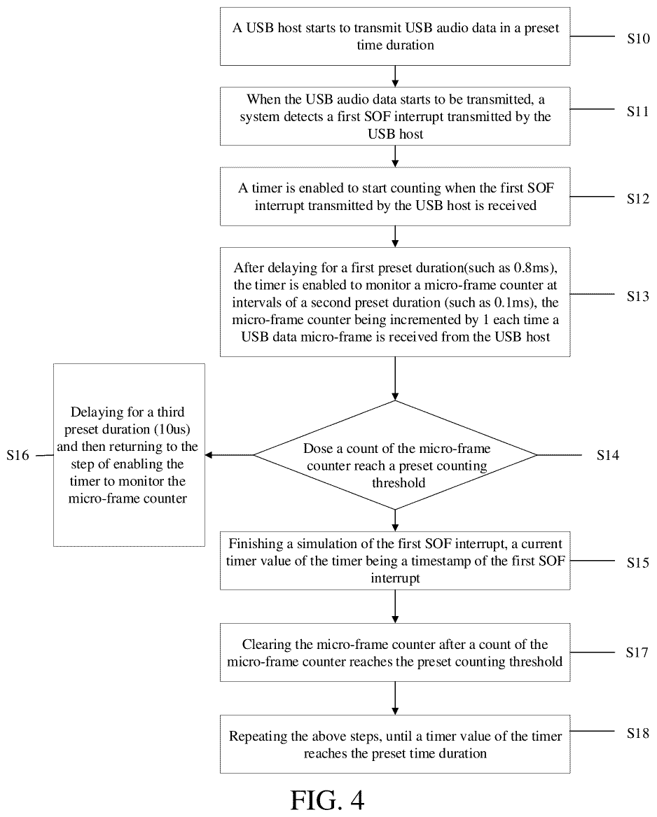

FIG. 4 is a flow chart for recording the timestamp of the SOF interrupt according to an embodiment of the present disclosure. As shown in FIG. 4, the process of recording the timestamp of the SOF interrupt at least includes steps S10-S18.

At step S10, a USB host starts to transmit USB audio data in a preset time duration.

At step S11, when the USB audio data starts to be transmitted, a system detects a first SOF interrupt transmitted by the USB host.

At step S12, a timer is enabled to start counting when the first SOF interrupt transmitted by the USB host is received.

At step S13, after delaying for a first preset duration (such as 0.8 ms), the timer is enabled to monitor a micro-frame counter at intervals of a second preset duration (such as 0.1 ms), the micro-frame counter being incremented by 1 each time a USB data micro-frame is received from the USB host.

At step S14, it is determined whether the count of the micro-frame counter reaches a preset counting threshold. If yes, the process proceeds to step S15; if no, the process proceeds to step S16.

At step S15, a simulation of the first SOF interrupt is finished, a current timer value of the timer is a timestamp of the first SOF interrupt.

At step S16, after delaying for a third preset duration (10 us), the process returns to the step of enabling the timer to monitor the micro-frame counter.

At step S17, the micro-frame counter is cleared after the count of the micro-frame counter reaches a preset counting threshold.

At step S18, the above steps are repeated, until a timer value of the timer reaches a preset time duration.

In summary, by continuously cycling through the aforementioned step of the timer monitoring the micro-frame counter, the timestamps of the SOF interrupts can be persistently recorded during a audio data transmission process. Through continuous timestamp recordings, the system can accumulate sufficient data to facilitate subsequent analysis and adjustment of clock frequency.

In some embodiments, the obtaining the fitted curve of timestamps based on the recorded timestamps of the SOF interrupts includes: obtaining data of timestamps of the SOF interrupts within a fourth preset duration from the USB host starting to play data for the first time; and obtaining the fitted curve of timestamps based on the data of timestamps of the SOF interrupts using a linear regression model.

The fourth preset duration can be a time window from the USB host starting to play audio data to recording of the SOF interrupt timestamp. The time window is primarily used to ensure capturing a sufficient number of SOF interrupt timestamps during the USB audio playback phase, thereby providing adequate data samples for subsequent linear regression. A selection of the time window directly affects a precision of the synchronization process. An excessively short time window may lead to insufficient sample number, while an overly long time window could affect the system's real-time performance.

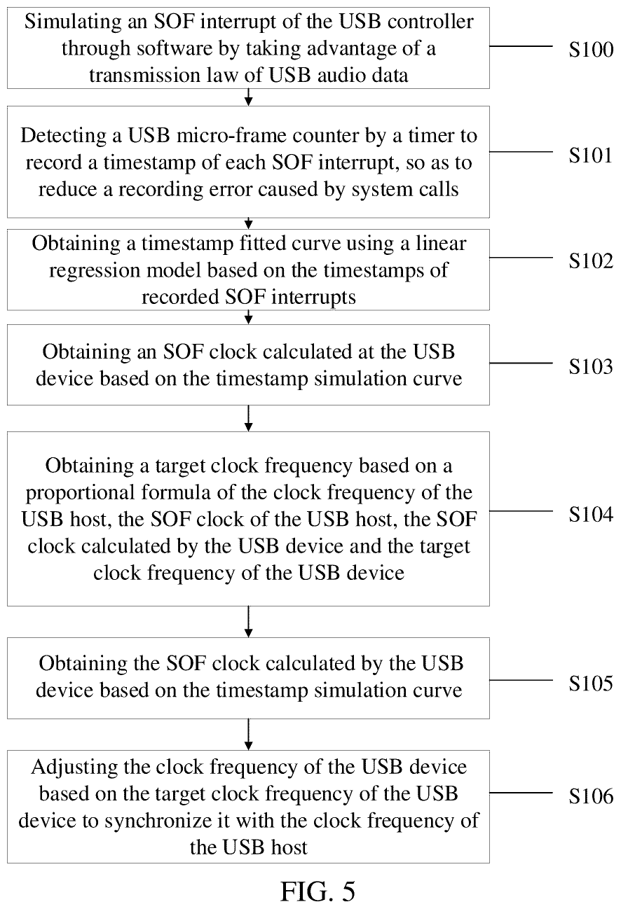

In some embodiments, as shown in FIG. 5, the fourth preset duration can be set to 20 ms. For USB full-speed transmission, each frame cycle is Ims. 20 ms means that it is able to capture timestamp data of approximately 20 SOF interrupts, which is sufficient for fitting the clock difference between the device end and the host. Moreover, while ensuring synchronization accuracy, it will not impose excessive impact on the real-time performance of the USB audio data.

Furthermore, the timestamp data of a plurality of SOF interrupts collected within 20 ms is inputted into a linear regression model for fitting. The linear regression model can reduce errors in SOF interrupt timestamp records through the least squares method, identifying a curve that best reflects clock synchronization conditions. The least squares method is a commonly used regression analysis technique. By minimizing the sum of squared errors between predicted values and actual observed values, the optimal fitted curve is identified. For USB audio synchronization methods, the system can utilize the timestamps of multiple SOF interrupts as input samples. A timestamp curve is fitted by using the least squares method to estimate an actual SOF interrupt timestamp.

In some embodiments, the SOF clock calculated by the USB device is a slope of a timestamp simulation curve. Theoretically, during USB full-speed transmission, the SOF clock signal appears once every 1 ms. Therefore, ideally the slope should be 1 ms. However, due to clock deviation or transmission delay, the actual slope may slightly deviate. By calculating this slope value, the device can monitor the clock synchronization status between the device and the host.

In some embodiments, the obtaining the target clock frequency of the USB device based on the clock frequency of the USB host, the SOF clock of the USB host and the SOF clock calculated by the USB device includes: obtaining the target clock frequency based on a proportional formula of the clock frequency of the USB host, the SOF clock of the USB host, the SOF clock calculated by the USB device and the target clock frequency of the USB device. that is to say, through the proportional formula, the device can utilize the known relationship between the SOF clock of the USB host and the clock frequency of the USB host, along with the SOF clock calculated by the USB device, to calculate the target clock frequency that requires adjustment. This ensures clock synchronization between the device and the host. Especially in the process of the audio transmission, for scenarios with high timing requirements, the method can effectively prevent data loss and audio inconsistency.

In some embodiments, the target clock frequency of the USB device is obtained by the formula of:

$$\frac{{F}_{d} - {F}_{h}}{{F}_{d}} \times {10}^{6} = \frac{{T}_{d} - {T}_{h}}{{T}_{d}} \times {10}^{6} ;$$

Wherein, F_{d} is the target clock frequency, Fₕ is the clock frequency of the USB host, T_{d} is the SOF clock calculated by the USB device, and Tₕ is the SOF clock of the USB host. The left side of the equation

$$\frac{{F}_{d} - {F}_{h}}{{F}_{d}} \times {10}^{6}$$

can represent the difference between the host clock frequency and the device clock frequency, and can be expressed with one part per million accuracy. The right side of the equation

$$\frac{{T}_{d} - {T}_{h}}{{T}_{d}} \times {10}^{6}$$

can represent the difference between the host SOF clock and the device SOF clock, that is the error in the SOF timestamp, and can also be expressed with one part per million accuracy.

FIG. 5 is an overall flowchart of an audio synchronization method for a USB device according to an embodiment of the present disclosure. As shown in FIG. 5, the overall flowchart of an audio synchronization method for a USB device at least includes steps S100-S106.

At step S100, an SOF interrupt of a USB controller is simulated through software by taking advantage of a transmission law of USB audio data.

At step S101, a USB micro-frame counter is detected by a timer to record a timestamp of each SOF interrupt, so as to reduce a recording error caused by system calls.

At step S102, a timestamp fitted curve is obtained using a linear regression model based on the timestamps of recorded SOF interrupts.

At step S103, an SOF clock calculated at the USB device is obtained based on the timestamp simulation curve.

At step S104, a target clock frequency is obtained based on a proportional formula of the clock frequency of the USB host, the SOF clock of the USB host, the SOF clock calculated by the USB device and the target clock frequency of the USB device.

At step S105, the SOF clock calculated by the USB device is obtained based on the timestamp simulation curve.

At step S106, the clock frequency of the USB device is determined to be adjusted based on the target clock frequency of the USB device to synchronize the clock frequency of the USB device with the clock frequency of the USB host.

In summary, the audio synchronous transmission between the USB host and USB device is achieved through the steps of the above method, effectively reducing the accumulation errors of audio data caused by clock frequency inconsistency, thereby avoiding the issues of audio data loss or inaccurate synchronization. At the same time, since the method is based on the SOF interrupts and timestamp calculations rather than relying on specific USB host hardware, it ensures the adaptability of the method to any type of the USB host, thereby improving the universality of USB audio data transmission and meeting audio transmission requirements for high real-time performance and high precision.

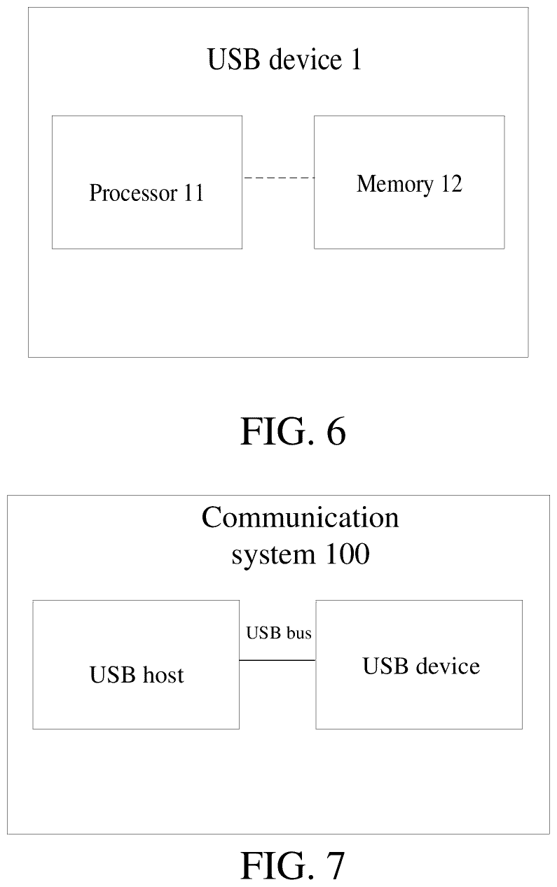

A USB device according to an embodiment of the present disclosure will be described below with reference to FIG. 6.

FIG. 6 is a block diagram of a USB device according to an embodiment of the present disclosure. As shown in FIG. 6, a USB device 1 includes: a memory 12 and at least one processor 11.

In some embodiments, the at least one processor 11 can be one processor 11, two processors 11, three processors 11, or five processors 11 and so on. Th processor 11 is responsible for handling all calculation tasks during USB audio synchronization, including capturing the SOF interrupt signals, recording timestamps of the SOF interrupts, fitting timestamp curves, adjusting the clock frequency of the USB device, etc. According to requirements of different devices, the processor 11 can be a single-core processor or a multi-core processor to enhance processing capability. The types of processor 11 may include: a microcontroller (MCU), a digital signal processor (DSP), a central processing unit (CPU), etc.

In some embodiments, the memory 12 can be a random access memory (RAM), a read-only memory (ROM), or a flash memory, ensuring fast access and persistent storage of programs during operation.

In some embodiments, the memory 12 is communicatively connected to the at least one processor. The memory 12 stores a computer program executable by the at least one processor 11. The computer program when executed by the at least one processor 11, implements the audio synchronization method for a USB device according to any of the above embodiments.

According to the USB device 1 of the embodiment of the present disclosure, at least one processor 11, by executing a computer program that implements the USB audio synchronization method described in the above embodiments, can synchronize the clock frequency of the USB device 1 with the clock frequency of the USB host. Specifically, by simulating SOF interrupts through software and recording the timestamps of SOF interrupts, the SOF clock calculated by the USB device can be obtained. The clock can accurately reflect the clock frequency variations of the USB device during actual operation. By combining the clock frequency of the USB host and the SOF clock of the USB host, the target clock frequency of the USB device can be calculated. The target clock frequency can accurately reflect the frequency difference between the USB host and the USB device. By adjusting the clock frequency of the USB device in real time, synchronized audio transmission between the USB host and USB device is achieved, effectively reducing the accumulation errors of audio data caused by clock frequency inconsistency, thereby avoiding the issue of audio data loss or inaccurate synchronization. At the same time, since the method is based on the SOF interrupts and timestamp calculations rather than relying on specific USB host hardware, it ensures the adaptability of the method to any type of the USB host, thereby improving the universality of USB audio data transmission and can meet audio transmission requirements for high real-time performance and high precision.

An embodiment of the present disclosure provides a non-transitory computer readable storage medium on which a computer program is stored. The computer program when executed, implements the audio synchronization method for a USB device according to any of the above embodiments. For the detailed implementation of the audio synchronization method for a USB device, please refer to the description in the above embodiments.

The computer readable storage medium according to the embodiment of the present disclosure, by using the audio synchronization method for a USB device in any of the above embodiments, can achieve real-time adjustment of the clock frequency of the USB device, can achieve synchronous audio transmission between the USB host and the USB device, and can reduce the accumulation errors of audio transmission and avoid the issue of data loss or inaccurate synchronization. At the same time, it is no longer limited to specific USB host hardware, thereby improving the universality of USB audio data transmission and meeting the requirements of high real-time performance and high-precision audio transmission.

A communication system according to an embodiment of the present disclosure is described below with reference to FIG. 7. FIG. 7 is a block diagram of a communication system according to an embodiment of the present disclosure. As shown in FIG. 7, the communication system 100 includes: a USB host 2 and at least one USB device 1 according to any of the above embodiments.

In some embodiments, the USB host 2 serves as a control center for the entire USB communication system 100. The USB host 2 is communitively connected to the USB device via a USB bus, and is responsible for managing communication of the USB device 1. The USB host 2 can be a computer, a smartphone, a tablet, or any device with USB control capabilities. The USB host 2 possesses robust processing capabilities, enabling it to handle audio, video, or other data streams from multiple USB devices 1. The USB host 2 is also responsible for generating the SOF signal, ensuring that all connected USB devices 1 operate at the same clock frequency, thereby achieving data timing synchronization.

In some embodiments, the USB device 1 can be various peripherals, such as an audio interface, an audio converter, a microphone, a speakers, etc. Each USB device 1, when communicating with the USB host 2, can achieve accurate data transmission and synchronization based on the SOF signal from USB host 2 by adopting the USB audio synchronization method described in any of the above embodiments.

In some embodiments, the USB bus is a physical transmission channel connecting the USB host 2 and the USB device 1. Data transmission, control signal interaction, and power supply can be achieved between the USB host 2 and the USB device 1 via the USB bus. The design of the USB bus allows a plurality of USB devices 1 to connect to the host via the same bus, and supports a hot-plugging function and a plug-and-play function.

In some embodiments, the USB bus supports a plurality of communication protocols, including a control transfer protocol, a synchronous transfer protocol, a bulk transfer protocol, and an interrupt transfer protocol. These protocols ensure a reliability and high efficiency of data transmission, and can be adapted to requirements of different types of data.

According to the communication system 100 of the embodiment of the present disclosure, the USB host 2 is communitively connected to the USB device 1 via a USB bus. By simulating SOF (Start of Frame) interrupts through software and recording the timestamps of SOF interrupts, the SOF clock calculated by the USB device can be obtained. The clock can accurately reflect the clock frequency variation of the USB device during actual operation. By combining the clock frequency of the USB host and the SOF clock of the USB host, the target clock frequency of the USB device can be calculated. The target clock frequency can accurately reflect the frequency difference between the USB host and the USB device. By adjusting the clock frequency of the USB device in real-time, the synchronous audio transmission between the USB host and the USB device is achieved, effectively reducing the accumulation errors of audio data caused by clock frequency inconsistency, thereby avoiding the issue of audio data loss or inaccurate synchronization. At the same time, since the method is based on the SOF interrupts and timestamp calculations rather than relying on specific USB host hardware, it ensures the adaptability of the method to any type of the USB host 2, thereby improving the universality of USB audio data transmission and can meet audio transmission requirements for high real-time performance and high precision.

In the description of the specification, descriptions with reference to terms such as “one embodiment,” “some embodiments,” “illustrative embodiment,” “example,” “specific example,” or “some examples” mean that the specific features, structures, materials, or characteristics described in connection with the embodiment or example are included in at least one embodiment or example of the present disclosure. In this specification, the illustrative descriptions of the aforementioned terms do not necessarily refer to the same embodiment or example.

Although the embodiments of the present disclosure have been shown and described, those of ordinary skill in the art can understand that various changes, modifications, substitutions, and variations can be made to these embodiments without departing from the principles and spirit of the present disclosure. The scope of the present disclosure is defined by the claims and their equivalents.

What is claimed is:

1. An audio synchronization method for a USB device, comprising:
obtaining an SOF clock calculated by the USB device, the SOF clock calculated by the USB device being obtained by simulating an SOF interrupt through software and recording a timestamp of the SOF interrupt;
obtaining a target clock frequency of the USB device based on a clock frequency of a USB host, an SOF clock of the USB host and the SOF clock calculated by the USB device; and
adjusting a clock frequency of the USB device based on the target clock frequency of the USB device.

2. The audio synchronization method for a USB device according to claim 1, wherein said obtaining the SOF clock calculated by the USB device comprises:
simulating SOF interrupts in a preset time duration through software and recording the timestamp of each SOF interrupt;
obtaining a fitted curve of timestamps based on the recorded timestamps of the SOF interrupts; and
obtaining the SOF clock calculated by the USB device based on the fitted curve of timestamps.

3. The audio synchronization method for a USB device according to claim 2, wherein the preset time duration is a preset time duration in which the USB host starts to send USB data.

4. The audio synchronization method for a USB device according to claim 2, wherein said simulating the SOF interrupts in the preset time duration through the software and recording the timestamp of each SOF interrupt comprises:
enabling a timer to start counting when receiving a first SOF interrupt sent by the USB host;
enabling, after delaying for a first preset duration, the timer to monitor a micro-frame counter at intervals of a second preset duration, the micro-frame counter being incremented by 1 each time a USB data micro-frame is received from the USB host, the first preset duration being shorter than a time interval at which the USB host sends the SOF interrupt, the second preset duration being shorter than the first preset duration; and
finishing, in response to a count of the micro-frame counter reaching a preset counting threshold, a simulation of the first SOF interrupt, a current timer value of the timer being a timestamp of the first SOF interrupt.

5. The audio synchronization method for a USB device according to claim 4, wherein the first preset duration+the second preset duration*the preset counting threshold=the time interval at which the USB host sends the SOF interrupt.

6. The audio synchronization method for a USB device according to claim 4, wherein said simulating the SOF interrupts in the preset time duration through the software and recording the timestamp of each SOF interrupt further comprises:
performing a polling step, the polling step comprising:
clearing the micro-frame counter after a count of the micro-frame counter reaches the preset counting threshold, and enabling, after delaying for the first preset duration, the timer to count to monitor the micro-frame counter at intervals of the second preset duration, finishing, in response to the count of the micro-frame counter reaching the preset counting threshold, the simulation of one SOF interrupt, the current timer value of the timer being the timestamp of the SOF interrupt that is currently being simulated;
repeating the polling step, until a timer value of the timer reaches the preset time duration.

7. The audio synchronization method for a USB device according to claim 6, further comprising:
delaying, when the count of the micro-frame counter does not reach the preset counting threshold, for a third preset duration and then returning to the step of enabling the timer to monitor the micro-frame counter, the third preset duration being shorter than the second preset duration.

8. The audio synchronization method for a USB device according to claim 4, wherein for a USB full-speed transmission mode, a value of the first preset duration t1 meets: 0.75 ms≤t1≤0.85 ms.

9. The audio synchronization method for a USB device according to claim 2, wherein said obtaining the fitted curve of timestamps based on the recorded timestamps of the SOF interrupts, comprises:
obtaining data of timestamps of the SOF interrupts within a fourth preset duration from the USB host starting to play data for the first time; and
obtaining the fitted curve of timestamps based on the data of timestamps of the SOF interrupts using a linear regression model.

10. The audio synchronization method for a USB device according to claim 2, wherein the SOF clock calculated by the USB device is a slope of a timestamp simulation curve.

11. The audio synchronization method for a USB device according to claim 1, wherein said obtaining the target clock frequency of the USB device based on the clock frequency of the USB host, the SOF clock of the USB host and the SOF clock calculated by the USB device comprises:
obtaining the target clock frequency based on a proportional relationship of the clock frequency of the USB host, the SOF clock of the USB host, the SOF clock calculated by the USB device and the target clock frequency of the USB device.

12. The audio synchronization method for a USB device according to claim 1, wherein the target clock frequency of the USB device is obtained by the formula of:
$$\frac{{F}_{d} - {F}_{h}}{{F}_{d}} \times {10}^{6} = \frac{{T}_{d} - {T}_{h}}{{T}_{d}} \times {10}^{6}$$
Wherein, F_{d} is the target clock frequency, Fₕ is the clock frequency of the USB host, T_{d} is the SOF clock calculated by the USB device, and Tₕ is the SOF clock of the USB host.

13. A USB device, comprising:
at least one processor; and
a memory communicatively connected to the at least one processor;
wherein the memory stores a computer program executable by the at least one processor, the computer program when executed by the at least one processor, implements operations of:
obtaining an SOF clock calculated by the USB device, the SOF clock calculated by the USB device being obtained by simulating an SOF interrupt through software and recording a timestamp of the SOF interrupt;
obtaining a target clock frequency of the USB device based on a clock frequency of a USB host, an SOF clock of the USB host and the SOF clock calculated by the USB device; and
adjusting a clock frequency of the USB device based on the target clock frequency of the USB device.

14. The USB device according to claim 13, wherein said obtaining the SOF clock calculated by the USB device comprises:
simulating SOF interrupts in a preset time duration through software and recording the timestamp of each SOF interrupt;
obtaining a fitted curve of timestamps based on the recorded timestamps of the SOF interrupts; and
obtaining the SOF clock calculated by the USB device based on the fitted curve of timestamps.

15. The USB device according to claim 14, wherein the preset time duration is a preset time duration in which the USB host starts to send USB data.

16. The USB device according to claim 14, wherein said simulating the SOF interrupts in the preset time duration through the software and recording the timestamp of each SOF interrupt comprises:
enabling a timer to start counting when receiving a first SOF interrupt sent by the USB host;
enabling, after delaying for a first preset duration, the timer to monitor a micro-frame counter at intervals of a second preset duration, the micro-frame counter being incremented by 1 each time a USB data micro-frame is received from the USB host, the first preset duration being shorter than a time interval at which the USB host sends the SOF interrupt, the second preset duration being shorter than the first preset duration; and
finishing, in response to a count of the micro-frame counter reaching a preset counting threshold, a simulation of the first SOF interrupt, a current timer value of the timer being a timestamp of the first SOF interrupt.

17. The USB device according to claim 16, wherein the first preset duration+the second preset duration*the preset counting threshold=the time interval at which the USB host sends the SOF interrupt.

18. The USB device according to claim 15, wherein said simulating the SOF interrupts in the preset time duration through the software and recording the timestamp of each SOF interrupt further comprises:
performing a polling step, the polling step comprising:
clearing the micro-frame counter after a count of the micro-frame counter reaches the preset counting threshold, and enabling, after delaying for the first preset duration, the timer to count to monitor the micro-frame counter at intervals of the second preset duration, finishing, in response to the count of the micro-frame counter reaching the preset counting threshold, the simulation of one SOF interrupt, the current timer value of the timer being the timestamp of the SOF interrupt that is currently being simulated;
repeating the polling step, until a timer value of the timer reaches the preset time duration.

19. A non-transitory computer readable storage medium, on which a computer program is stored, wherein the computer program when executed, implements operations of:
obtaining an SOF clock calculated by the USB device, the SOF clock calculated by the USB device being obtained by simulating an SOF interrupt through software and recording a timestamp of the SOF interrupt;
obtaining a target clock frequency of the USB device based on a clock frequency of a USB host, an SOF clock of the USB host and the SOF clock calculated by the USB device; and
adjusting a clock frequency of the USB device based on the target clock frequency of the USB device.

20. A communication system, comprising a USB host and at least one USB device according to claim 13, the USB host being communitively connected to the USB device via a USB bus.
